(19) United States
(12) Patent Application Publication
(10) Pub. No.: US 2021/0288379 A1
(43) Pub. Date: Sep. 16, 2021

(54) HIGH DENSITY BATTERY MODULE WITH THERMAL ISOLATION

(71) Applicant: Lithos Energy, Inc., San Rafael, CA (US)

(72) Inventors: James Meredith, Corte Madera, CA (US); Robert Wayne Sweney, San Francisco, CA (US)

(21) Appl. No.: 17/202,172

(22) Filed: Mar. 15, 2021

Related U.S. Application Data
(60) Provisional application No. 62/989,778, filed on Mar. 15, 2020.

(51) Int. Cl. H01M 50/375; H01M 50/503; H01M 50/383; H01M 10/6555; H01M 10/613

(52) U.S. Cl. CPC H01M 50/375; H01M 50/503; H01M 10/613; H01M 10/6555; H01M 50/383

(57) ABSTRACT

A battery module construction that provides passive resistance to propagation of cell failure, such as thermal runaway. The walls of cells of a battery module may be thermally isolated from each other by securing cells in a frame formed of thermal insulating material, separating the cells from one another, thereby limiting thermal energy from propagating directly between adjacent cells. A vent layer may permit ejection of hot gases and other ejecta into an air gap above the cells, venting the ejecta and dissipating thermal energy. The vent layer may be formed from, e.g., a frangible layer of dielectric gel, or a plastic vent tray with apertures for venting of ejecta and passage of wiring with collectors mounted over the vent tray. A heat sink or cooling module may be thermally coupled to an opposite end of cells to further aid thermal energy removal from the module.

### TECHNICAL FIELD

The present disclosure relates in general to high energy density battery packs, and in particular to battery module constructions providing passive containment of thermal effects associated with battery cell thermal runaway.

### BACKGROUND

As battery cell technology and manufacturing capacity improves, electric battery cells are increasingly used in high energy applications. For example, energy dense yet cost-effective battery packs are critical to the commercial viability of electric vehicles and other motive applications that may have traditionally been powered by non-electric means.

One popular approach to create high energy-density battery packs is to combine very large quantities of small-format battery cells, such as rechargeable lithium ion cells, into a large format battery module and then combine the modules into battery packs. Dozens or hundreds of small-format battery cells may commonly be combined to deliver significantly higher levels of voltage and current output than would be possible from individual cells. The small-format battery cells may be produced in very high volume and very cost-effectively, while the capacity degradation of any individual cell may have very limited impact on the performance of a pack as a whole. For these and other reasons, large count small-format battery cell packs have become a predominant approach for high-energy applications such as electric vehicles.

However, such battery cell module construction presents several challenges. Rapid discharge of large volumes of tightly-packaged battery cells may result in the accumulation of significant amounts of heat within the cell module. Resulting high temperatures or other undesirable conditions may sometimes result in failure of cells within the cell module. In some circumstances, a battery cell within a cell module may undergo catastrophic failure, such as thermal runaway. Thermal runaway of a typical high-capacity battery cell, such as a lithium ion cell, may involve the generation and release of large amounts of thermal energy very quickly, including possible ejection of extremely hot gases and other materials inside of a cell module.

Such a catastrophic failure may quickly propagate to other cells within a high-density cell module, as thermal energy released by one failing cell induces similar thermal runaway in neighboring cells. Such scenarios may present significant risk of fire and/or destruction of the cell module, pack of modules and/or surrounding systems. In applications where people are present proximate the cell module, such as electric vehicles, such cell module failures may cause great inconvenience, and/or threaten an individual's safety. For these and other reasons, implementation of a high density, high energy cell module that is resistant to propagation of catastrophic cell failure may be highly desirable.

### SUMMARY

In accordance with one aspect of the disclosure, a battery module construction provides passive resistance to propagation of cell failure, such as thermal runaway. The walls of cells of a module may be thermally isolated from each other. A thermally insulating element may be placed between adjacent cells walls to limit thermal energy from propagating between adjacent cells. Cells of a battery module may be held in a frame formed of thermal insulating material. A battery module may also include a vent layer formed from a frangible thermal barrier at one end of the cells. In the event that a battery cell experiences thermal runaway, a resulting ejection of hot gas and detritus may displace a portion of the frangible thermal barrier above the failing cell, enabling the hot gas and detritus to vent into a designed area.

Portions of the frangible thermal barrier remaining over other cells in a cell module may provide thermal insulation from heat energy released from a failing cell, as well as physical protection from ejected detritus. Such an arrangement may be effective in mitigating the thermal and physical impact of a cell within a high-density cell module entering a thermal runaway condition, and passively preventing propagation of the thermal runaway condition to other cells within the cell module. A cell module may also include a heat sink or cooling module that is thermally coupled to an opposite end of cells of a cell module. The cooling module may include channels that enable liquid to travel therethrough to help aid thermal energy removal from a cell module. Also disclosed are particular constructions for a frangible thermal barrier, electric connections, and methods for installing such a barrier on a battery module.

In other embodiments, the vent layer may be formed from a vent tray, which may be formed from temperature-resistant plastic or other solid materials, overlying the top end of the battery cells. The vent tray includes apertures permitting electrical interconnection of underlying cells with overlying collector structures, as well as expulsion of ejecta from a failing cell into an air gap above the tray. Solid portions of the vent tray may cover portions of neighboring cells, helping to thermally-insulate the neighboring cells and/or inhibit exposure of the neighboring cells to corrosive materials and other detritus.

Various other objects, features, aspects, and advantages of the present invention and embodiments will become more apparent from the following detailed description of preferred embodiments, along with the accompanying drawings in which like numerals represent like components.

### BRIEF DESCRIPTION OF THE FIGURES

FIG. 1 is a simplified perspective view of a high density small-format cell battery module.

FIGS. 2A and 2B are exploded side views of a battery module.

FIG. 3A is a simplified isometric drawing of area AA of a battery module as shown in FIG. 1, further illustrating negative and positive electrical connections between electrical interconnection modules and cells.

FIG. 3B is a simplified isometric drawing of area AA of FIG. 3A, with several base electrical interconnector modules and base electrical interconnector module insulators removed.

FIG. 4A is a simplified isometric drawing of an electrical interconnection module insulator assembly.

FIG. 4B is a simplified isometric drawing of area BB of an electrical interconnection module insulator assembly.

FIG. 4C is a simplified rear side drawing of a corner of an electrical interconnection module.

FIG. 4D is a simplified enlarged rear side drawing of a segment of the corner of an electrical interconnection module.

FIG. 4E is a simplified enlarged rear side drawing of a segment of the corner of an electrical interconnection module.

FIG. 4F is a simplified enlarged rear side drawing of a segment of the corner of an electrical interconnection module.

FIG. 4G is a simplified isometric drawing of an electrical interconnector base electrical interconnector module.

FIG. 5 is a simplified isometric drawing of a battery cell used in a high density small-format cell battery module.

FIG. 6A is a simplified isometric drawing of a thermal isolation frame.

FIG. 6B is a simplified top plan view of a thermal isolation frame.

FIG. 6C is a simplified rear side or bottom plan view of a thermal isolation frame.

FIG. 6D is a partial perspective view of a portion of the rear or bottom side of a thermal isolation frame.

FIG. 6E is a simplified vertically segmented drawing of a thermal isolation frame.

FIG. 6F is a simplified horizontally segmented drawing of a thermal isolation frame.

FIG. 7A is a simplified isometric drawing of a cooling module.

FIG. 7B is a simplified vertically segmented drawing of a cooling module.

FIG. 7C is a simplified horizontally segmented drawing of a cooling module.

FIG. 8 is a top perspective view of a battery module incorporating a top side vent tray.

FIG. 9 is a partial, top perspective close up view of AREA CC of the battery module of FIG. 8.

FIG. 10 is a cross-sectional view of cross-section D-D of the battery module of FIG. 8, illustrating failure of a cell.

FIG. 11 is a cross-sectional view of cross-section D-D of the battery module of FIG. 8, illustrating a cell proximate another failing cell.

FIG. 12 is a partial top perspective view of a battery module, showing electrical interconnection of cells with collector plates through a vent tray.

### DETAILED DESCRIPTION

While this invention is susceptible to embodiment in many different forms, there are shown in the drawings and will be described in detail herein several specific embodiments, with the understanding that the present disclosure is to be considered as an exemplification of the principles of the invention to enable any person skilled in the art to make and use the invention, and is not intended to limit the invention to the embodiments illustrated.

Various embodiments described herein may inhibit propagation of catastrophic battery cell failure within a battery module along with other valuable features.

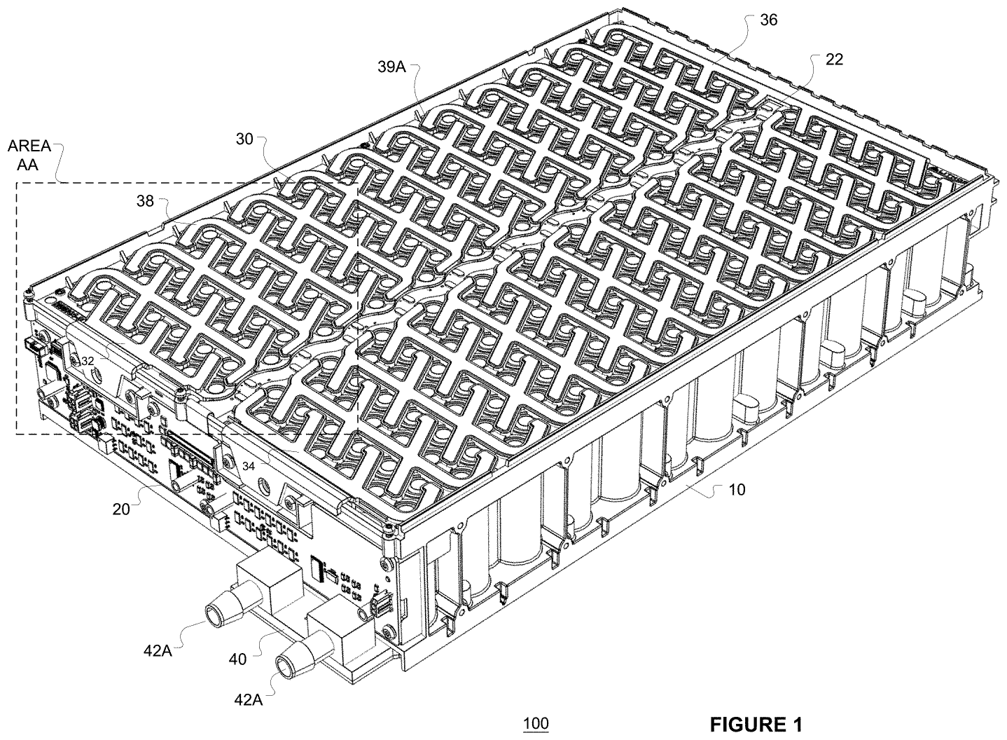

FIG. 1 is a simplified perspective view of segments of a high density small-format cell battery module (battery module) 100 according to embodiments of the invention. As shown in FIG. 1, module 100 includes a thermal isolation frame 10, a control board-circuit 20, a sensor board 22, an electrical interconnection module 30, and a cooling module 40. The battery module 100 supports or includes a large quantity of battery cells 50. The thermal isolation frame 10 may form the primary structure of the battery module 100 and be formed of a thermally isolating material. The thermal isolation frame (TIF) 10 material may also be electrically isolating or insulating. Thermal isolation frame 10 comprises an array of hollow sleeves extending between the top and bottom sides of the battery module 100, into which battery cells 50 are inserted during manufacture. Thermal isolation frame 10 thus operates to maintain battery cells 50 each in a predetermined position relative to module 100, separated from one another.

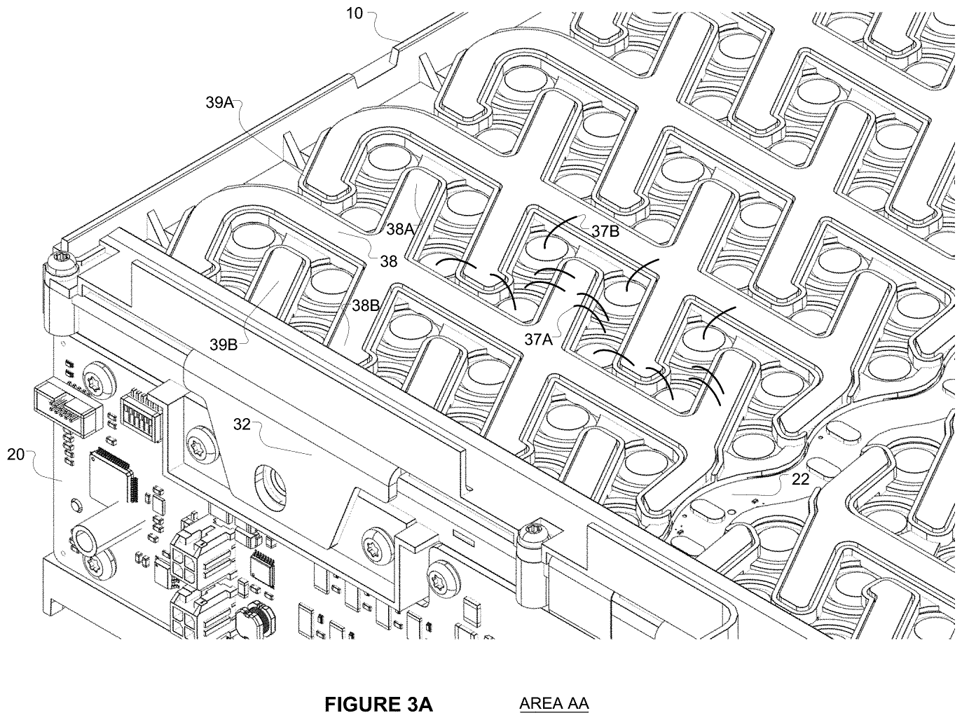

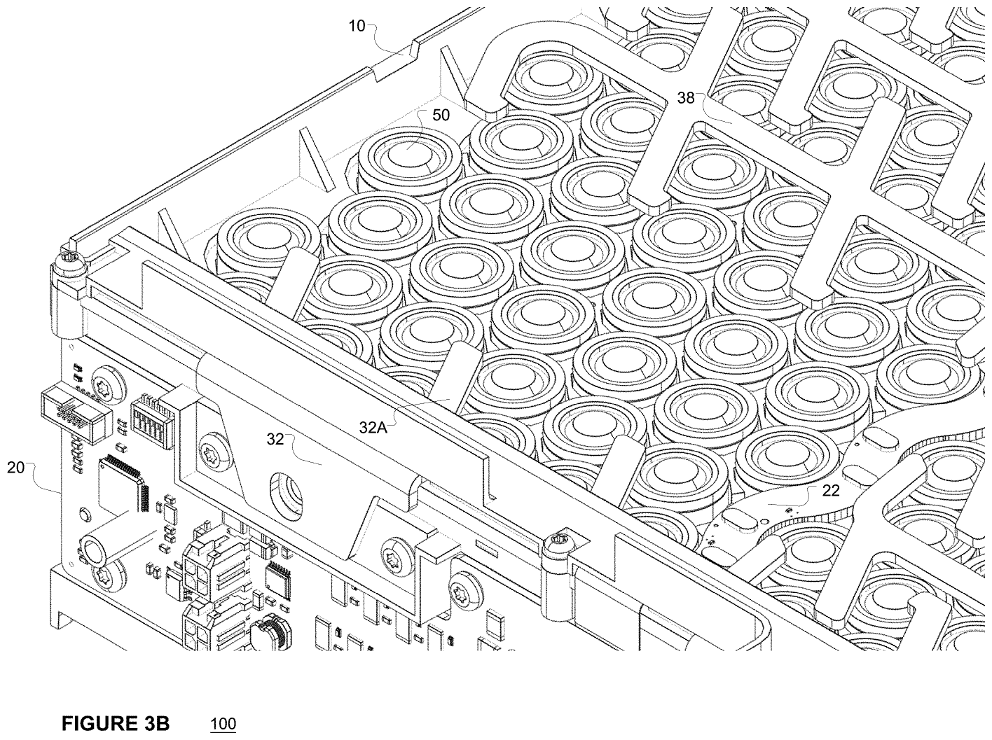

The electrical interconnection module (EIM) 30 includes a plurality of base electrical interconnector modules (base-eim) 38, a negative electrical interconnector module (neg-eim) 32, a positive electrical interconnector module (pos-eim) 34, cross electrical interconnector module (cross-eim) 36, and a plurality of electrical interconnector module electrical insulators 39 that are placed between the cells 50 and the eims 32, 34, 36, and 38. The EIM 30 may be coupled to the top side of the TIF 10. In an embodiment, the EIM 30 provides the structure for electrical connections between all the battery cells 50 of a module where electric connections are made between the cells 50 and eims 32, 34, 36, and 38 as shown in FIG. 3A. The cooling module 40 may be coupled to a bottom side of the TIF 10 and be liquid coolable via circulation of a coolant fluid through ports 42A-B.

FIG. 5 is a simplified isometric drawing of a battery cell 50 of a type that may be used in a high density small-format cell module (cell-module) as shown in FIG. 1 according to some embodiments. As shown in FIG. 5, a cell 50 may include a longitudinal, circular side wall 52 spanning and perpendicular to a base or bottom end 54, and top end 53 that includes electrodes (i.e. anode 56 and cathode 58 separated by an insulator 57). Cell 50 is cylindrical in shape, and oriented with its longitudinal axis 52 in the TIF 10 generally parallel to one another and having cell ends (53 and 54) that are aligned in common planes. In some embodiments, battery cells 50 may be specified as industry-standard sealed rechargeable lithium ion cells, such as an 18650 cell, or similarly sized cells with an anode and cathode on the top or proximal end 53.

The density of cells 50 within the large-format battery module 100, each of which may emit significant heat during rapid discharge, can lead to accumulation of significant amounts of heat energy within the battery module 100—particularly for cells embedded in the middle of a high-density field of cells 50. Heat energy may also build due to short circuit conditions or certain modes of cell 50 failure. A thermal condition may be reached at which a positive feedback loop is formed, and a cell 50 experiences thermal runaway. Typically, eventually, a sealed battery cell 50 experiencing thermal runaway will experience catastrophic failure of the sealed cell housing, releasing hot gas and materials from the cell 50. In particular, a common cell failure mode involves ejection of hot gas and detritus from the top and/or bottom of the cell 50. In many embodiments, cell 50 will be designed to fail only on the top end 53 due to the placements of the electrodes 56, 58 and an internal venting mechanism (not shown).

With cells 50 typically contained within a housing of some sort, hot gas and detritus expelled or ejected from an end of one cell is typically trapped proximate the top 53 of the failing cell 50. Because high power density and minimization of battery module size may be preferred, release of gas and other materials from a failing cell may expose neighboring cells to significant added heat energy, thereby encouraging thermal runaway in the neighboring cells as well. A catastrophic chain reaction may result. In order to avoid or minimize the risk of such an occurrence, cells 50 are mounted within battery module 100 each within a cell sleeve formed in TIF 10, where adjacent cells 50 are thereby thermally isolated from one another (along their walls 52) via a combination of air gap between adjacent cell sleeves, and/or via reduced thermal conductivity of the material from which TIF 10 is formed, greatly reducing the transmission of thermal energy between cells 50.

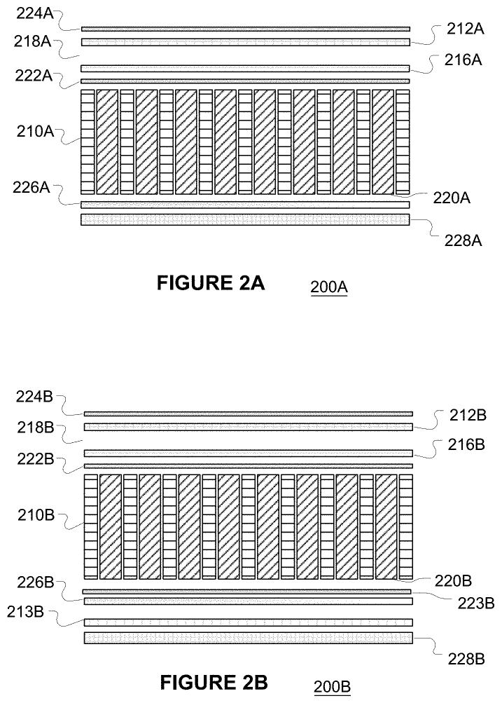

FIGS. 2A and 2B show exploded side views of a cell-module 200A, 200B according to embodiments of the invention. FIG. 2A illustrates an embodiment in which cells are interconnected with one another on a single side of the module (e.g. cells 50 having anodes and cathodes both at a cell top end 53 and interconnected on a top side of a module 100). FIG. 2B illustrates an embodiment in which cells are interconnected at both top and bottom sides of the module. FIGS. 2A and 2B include component layers (i.e. layers 212A-228A and 212B-228B, respectively) capable of avoiding or mitigating propagation of thermal runaway conditions amongst constituent cells 220A, 220B. In FIGS. 2A and 2B, cells 220A, 220B are arranged in an array, as described above, with top and bottom ends generally aligned with one another in a common plane. Thermally insulating material 210A, 210B may be placed between the walls 52 of adjacent cells 220A, 220B to limit the propagation of thermal energy between adjacent cells 220A, 220B. In some embodiments, thermally insulting material 210A, 210B may be formed as a portion of TIF 10 and a material from which TIF 10 is formed.

Preferably, TIF 10 and material 210A, 210B may effectively form a thermal, plastic sleeve around each cell, to maintain the position of each cell relative to TIF 10 and other battery module components, and also to provide thermal isolation between proximate cells. TIF 10, and particularly the cylinders formed thereby in which cells 50 may be inserted, may also provide mechanical support for cells 50, 220A, 200B thereby preventing or reducing the likelihood of a cell 50 experiencing sidewall rupture. In an exemplary embodiment, TIF 10 and material 210A, 210B may be a high temp glass filled nylon, that is also flame retardant.

Without thermal insulation between cells 50, 220A, 220B, a cell adjacent to a thermally failing cell may reach temperatures of 120 C, representing a +95 C temperature rise compared to standard 25 C operating conditions. In some embodiments, TIF 10 may reduce the temperature rise of cells 50 adjacent to a failing cell to only+10 C, improving module cost and performance and decreasing the likelihood of causing adjacent cell failure.

In FIG. 2A, cell interconnect layer 212A may serve to electrically connect groups of cells 220A (couple both anode and cathodes of cells 220A) with one another such as via EIM 30. In FIG. 2B, cell interconnect layers 212B and 213B may serve to electrically connect groups of cells 220B with one another. In some embodiments, cell interconnect layers 212A, 212B and/or 213B may be formed from copper plates, as described further in Applicant's U.S. patent application Ser. No. 16/177,746, titled COPPER COLLECTOR PLATE FOR HIGH POWER BATTERY MODULES, filed Nov. 1, 2018, the contents of which are hereby incorporated by reference in their entirety.

An upper frangible thermal barrier 216A, 216B may overlay top side cell interconnect insulator layers 222A, 222B, and lower non-frangible thermal conductor 226A, 226B may overlay the bottom side cell (interconnect insulator layer 223B in FIG. 2B). Exemplary constructions for frangible thermal barriers 216A, 216B are described further below.

Air gap 218A, 218B may be provided above a top frangible thermal barrier 216A, 216B, while a cooling plate or heat sink 228A, 228B is provided below a thermal conductor 226A, 226B. Enclosing air gaps 218A and 218B are electrical interconnectors 212A, 212B, and a system cover 224A, 224B. The system covers 224A, 224B may be formed from aluminum plates. Aluminum plates have been found to exhibit light weight, and sufficient physical durability and temperature resistance to resist deformation or damage from exposure to conditions during thermal runaway of a typical lithium ion cell. Aluminum also exhibits high thermal conductivity, such that a durable barrier formed from aluminum may help dissipate throughout the battery module the high concentration of thermal energy resulting from a cell undergoing thermal runaway. In some embodiments, it may be desirable to form each of durable system covers 224A, 224B from aluminum plates having a thickness of 2 mm; such a construction has been found to provide a desirable combination of weight, thermal dissipation and durability.

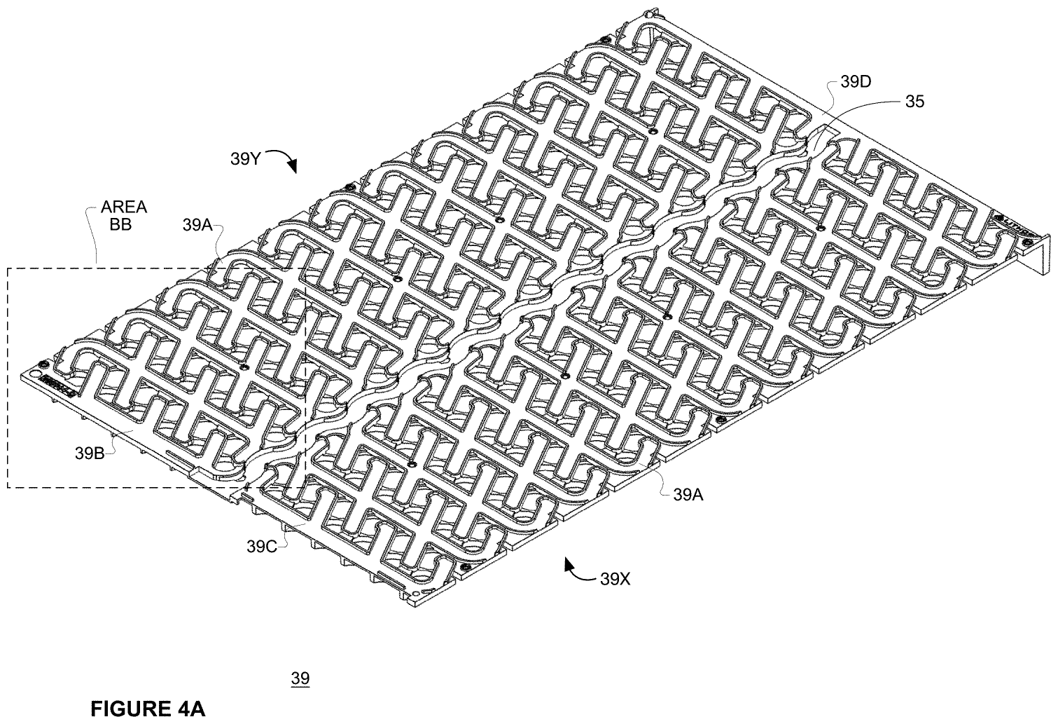

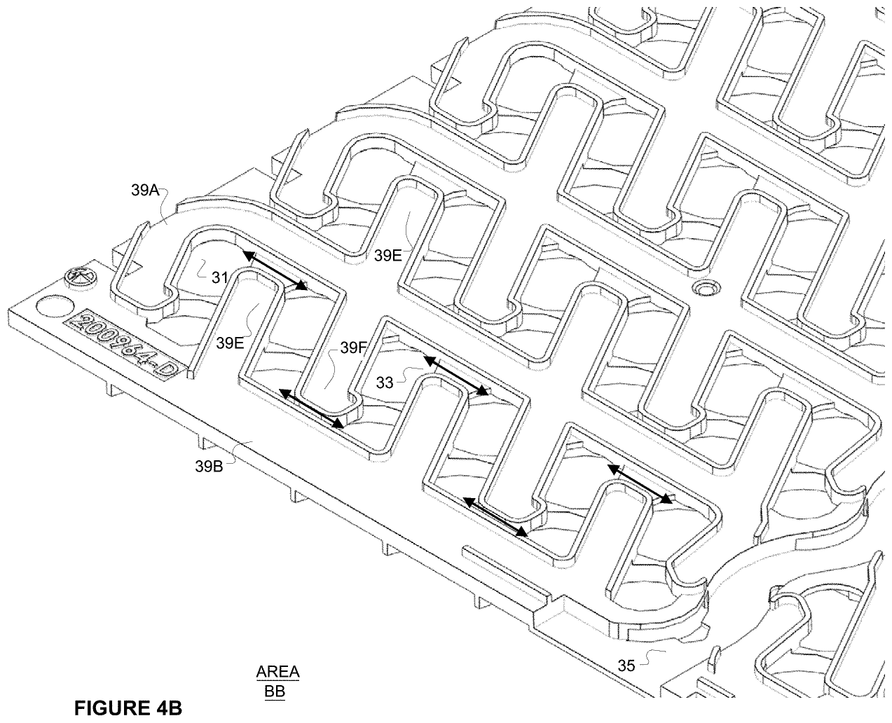

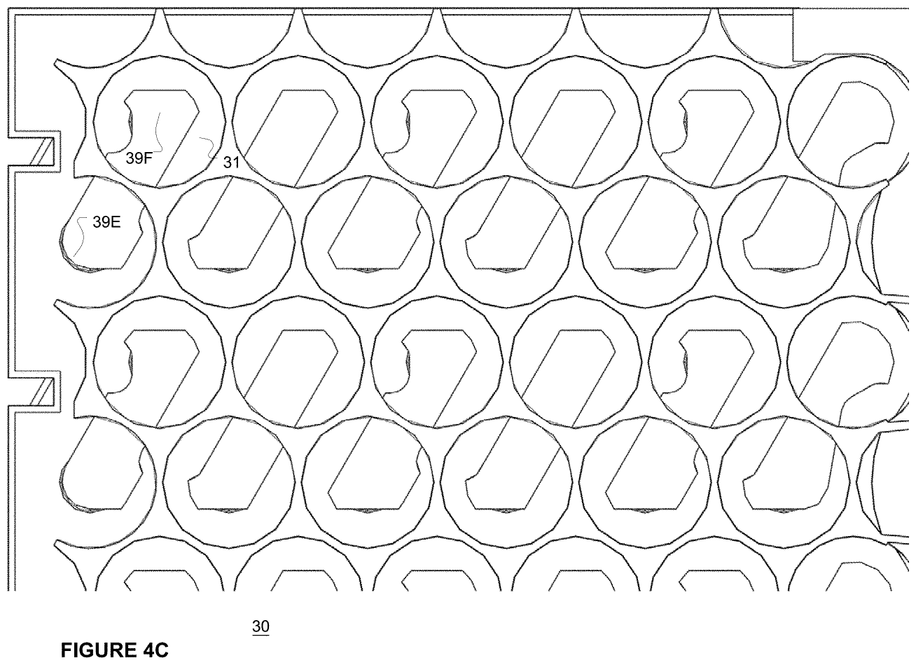

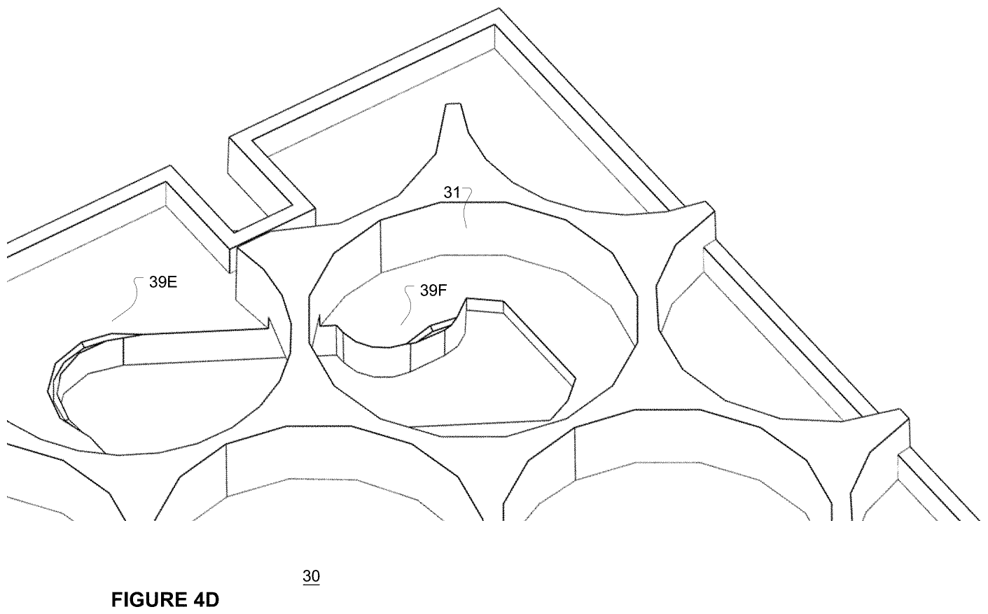

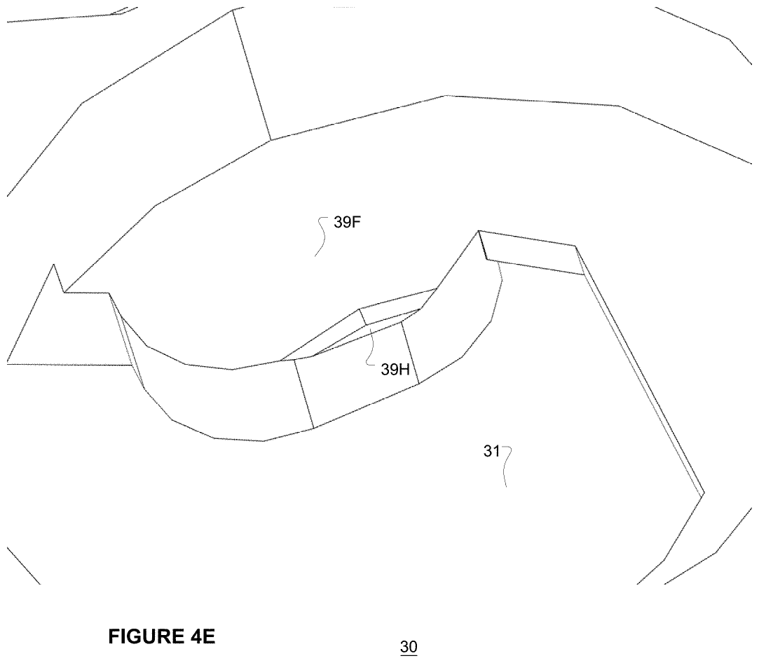

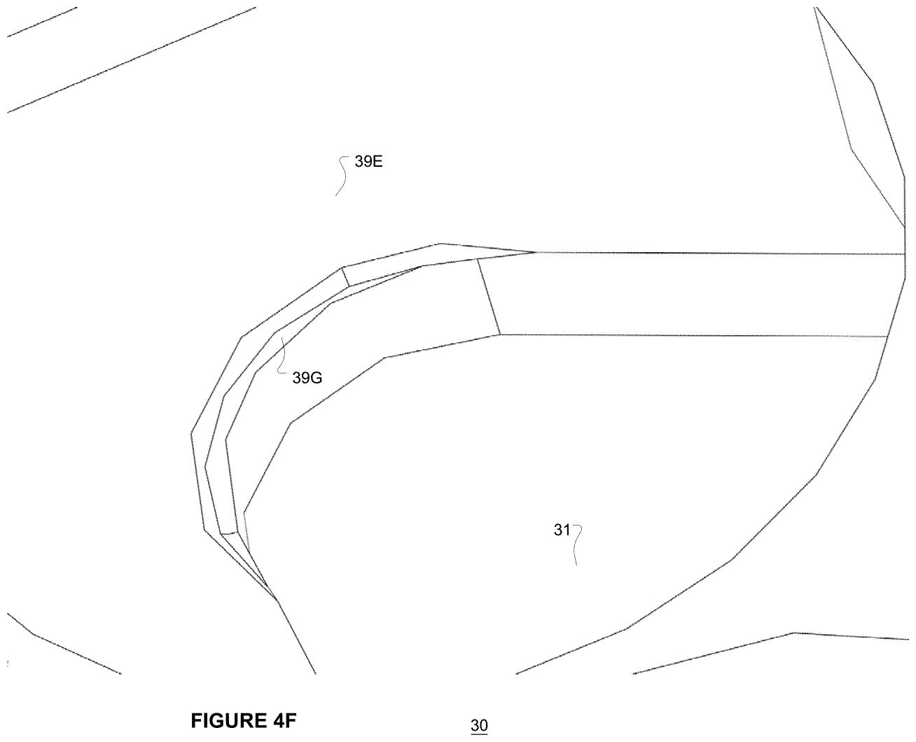

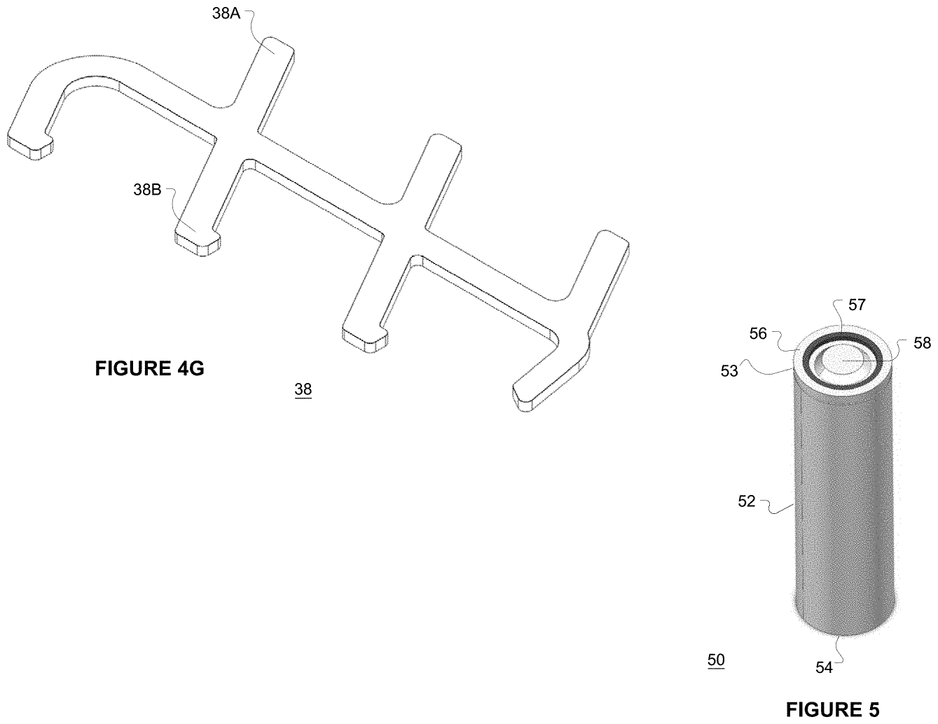

FIG. 4A is a simplified isometric drawing of an insulator assembly 39 component of electrical interconnection module (EIM) 30, as shown in FIG. 1, removed from module 100. Insulator assembly 39 is configured such that its bottom side 39X mounts onto TIF 10, and supports retention of cells 50 within TIF 10. Top side 39Y includes a plurality of inset channels for mounting of interconnector modules 32, 34, 36, and 38. Insulator assembly 39 includes a plurality of base electrical interconnector modules insulator (base-eim-insulator) 39A, a negative electrical interconnector module insulator (neg-eim-insulator) 39B, a positive electrical interconnector module insulator (pos-eim-insulator) 39C, cross electrical interconnector module insulator (cross-eim-insulator) 39D, and central insulator channel 35 for mounting of sensor board 22. Sensor board 22 may include sensors and/or wiring to implement distributed sensing (e.g. of temperature and/or voltage) within module 100. For example, temperature sensors implemented using sensor board 22 may inter alia control the flow of coolant liquid within cooling module 40.

FIG. 4B is a simplified isometric drawing of area BB of insulator assembly 39, as shown in FIG. 4A.

FIG. 3A is a simplified isometric drawing of area AA of a high density small-format cell module 100, including EIM 30. EIM 30 enables electrical connections (37A, 37B in FIG. 3A) between all the energy cells 50 of a battery module 100 where the cells 50 have their anode 56 and cathode 58 at the top end 53 of each cell 50.

As shown in FIG. 3A, a base-eim 38 and a neg-eim 32 may include arms 32A, 38A, 38B. Similarly, a base-eim-insulator 39A and neg-eim-insulator 39B may include arms 39E and 39F configured to enable arms of arms 32A, 38A, 38B of a base-eim 38 and neg-eim 32 to nest therein. Negative electrical connectors 37A may couple a base-eim negative arm (base-eim-neg-arm) 38A with an anode 58 of a cell 50. Positive electrical connectors 37B may couple a base-eim positive arm (base-eim-pos-arm) 38B with a cathode 56 of a cell 50. Not all negative electrical connectors 37A and positive electrical connectors 37B coupling cells 50 anodes 58 and cathodes 56 to base-eim-neg-arm 38A and base-eim-pos-arm 38B, respectively are shown in FIG. 3A for simplicity. Connectors 37A and 37B may be formed from any of a variety of structures or processes, such as wiring or wire bonding. In other embodiments, a portion of one or more eim-insulator-neg-arms 39E may be configured to engage or rest upon or about the anode (negative terminal) of a cell 50 and a portion of one or more eim-insulator-pos-arms 39F may be configured to engage or rest upon or about the cathode (positive terminal) of a cell 50.

FIG. 3B illustrates the location of cells 50 within module 100, with insulator assembly 39 having been removed for clarity.

As shown in FIG. 4B, insulator assembly 39 includes openings 31 in bottom side 39X, sized to enable a cell 50 top end 53 to pass therein. As also shown in FIG. 4B, gaps 33 may be included between arms 39E and 39F to enable gas and other materials to discharge from top 53 of a cell 50 (and shown by arrows).

In addition, in an embodiment, a frangible barrier 216A including an insulating gel may be deposited over at least EIM 30 opening 31 in an embodiment. The EIM 30 gaps 33 in arms 39E and 39F and cell 50 openings 31 may enable gas and detritus of a ruptured cell 50 to blast through into a cavity above the cells for thermal and gas venting. But the gaps 33 are sized to hold in most ejecta (material or detritus) from a failed cell 50, particularly when used with frangible barrier 216A, so that such ejecta doesn't contaminate other modules 100 or eject dangerous material elsewhere in an environment where a battery module 100 may be employed-installed. Gel on adjacent cells 50 may remain to provide a physical and thermal barrier for those cells 50 while the gas and detritus may move about the gaps to an opening in the EIM 30 and TIF 10.

The use of a gel material over a cell 50 opening 31 may increase the frangibility (lower its toughness) enabling the gel material 216A, 216B to rupture without tenting and enable a failing cell 50 to vent to more easily. A gel material 216A, 216B may also have high adhesion so it stays securely on the neighboring cells 50. In an embodiment, the gel material may be DOWSIL 3-4150 Dielectric Gel. A metallic system cover 226A, 226B over a EIM 30 may act as a heat sink for escaped gases. A battery module 100 TIF 10 may include a vent with an exit or exhaust port communicating between the air gap (e.g. air gap 218A, 218B) and areas outside of module 100, thereby enabling venting of gases and ejecta out of the battery module. The port may be sealed by a frangible material such as a sticker. The port frangible closure may keep the battery module 100 sealed to limit or inhibit the introduction of outside materials such as dust or moisture, but easily blow off to permit venting in the event of cells(s) 50 failure. In addition, a metal mesh may be placed on TIF 10 port exits to block or inhibit the passage of flames while allowing gases to pass therethrough.

FIG. 4C is a simplified bottom plan view (i.e. view towards bottom 39X) of a corner of EIM insulator assembly 39. FIG. 4D is a simplified enlarged rear side drawing (i.e. view towards bottom 39X) of a segment of the corner of an electrical interconnection module's (EIM) 30 cathode contacting arms (eim-insulator-pos-arm) 39F and anode contacting arms (eim-insulator-neg-arm) 39E. FIGS. 4C and 4D shows arms 39E and 39F extending into cell windows or openings 31 according to an embodiment.

FIG. 4E is a simplified enlarged rear side drawing of a segment of the corner of an electrical interconnection module's (EIM) 30 electrical interconnector module electrical insulator positive arm (eim-insulator-pos-arm) 39F as shown in FIG. 4D. FIG. 4F is a simplified enlarged rear side drawing of a segment of the corner of an electrical interconnection module's (EIM) 30 electrical interconnector module electrical insulator negative arm (eim-insulator-neg-arm) 39E as shown in FIG. 4D. As shown in FIGS. 4E and 4F, the arms 39E and 39F may include detents 39G and 39H, respectively that enable the arms 39E and 39F to nest adjacent to the respective anode 56 and cathode 58 respectively of a cell 50.

FIG. 4G is a simplified isometric drawing of a base-eim 38 as shown in FIG. 1. As shown in FIG. 4G, 3A and others, base-eim 38 is sized to extend vertically and be exposed above insulator assembly 39 to enable electric connections between base-eim 38 and cells 50 via electric connectors 37A, 37B.

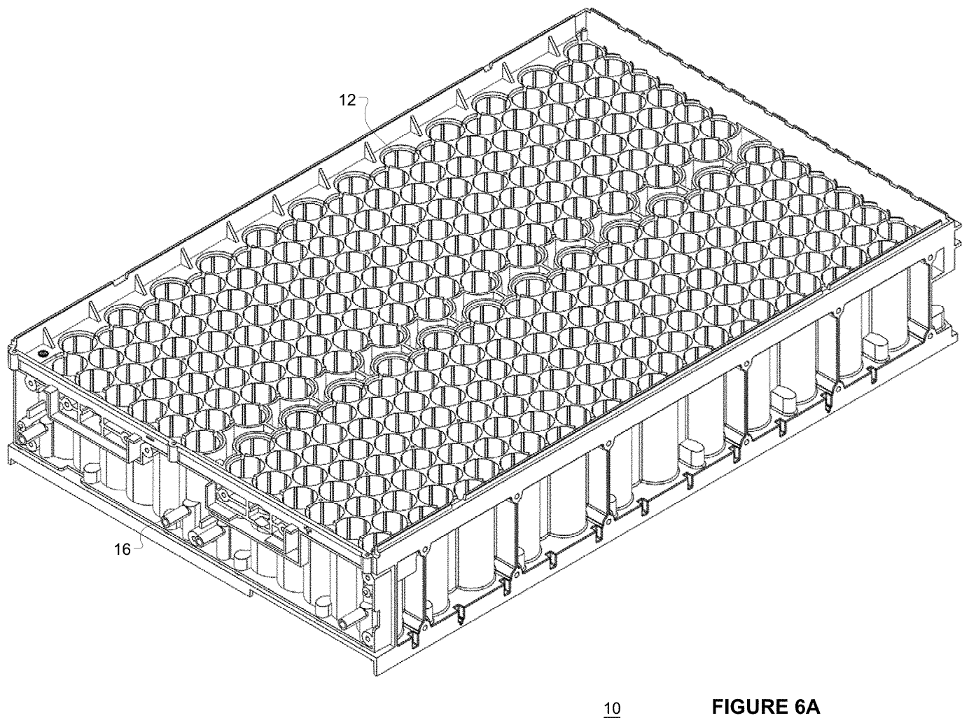

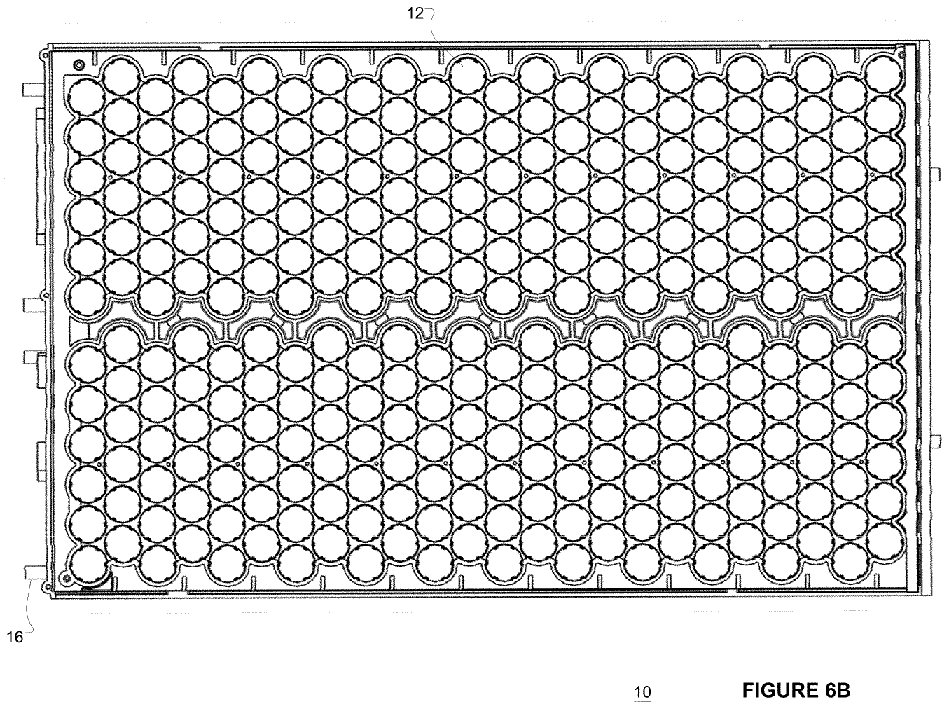

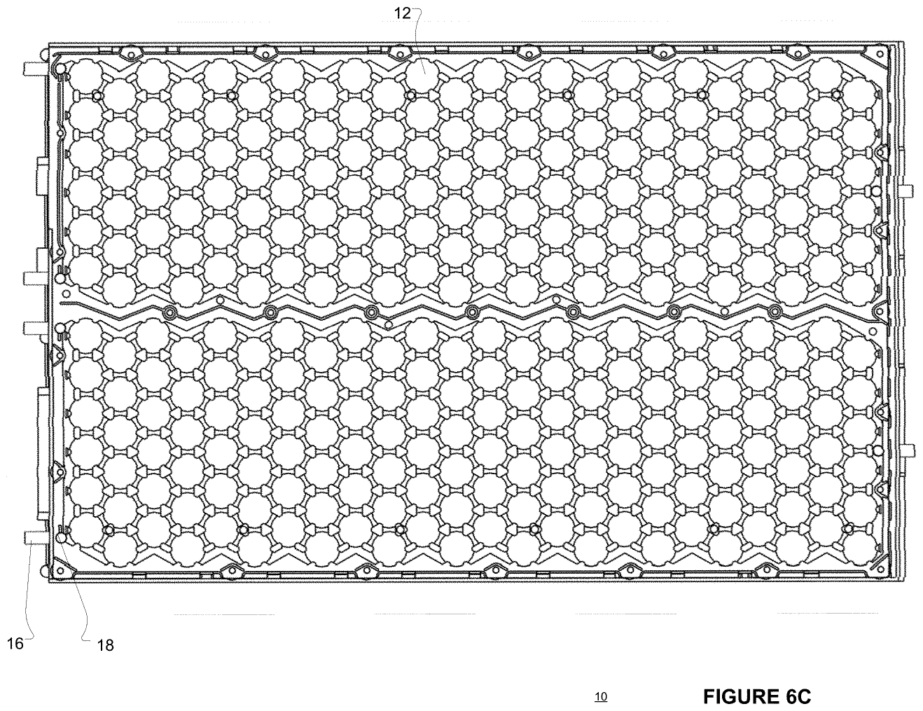

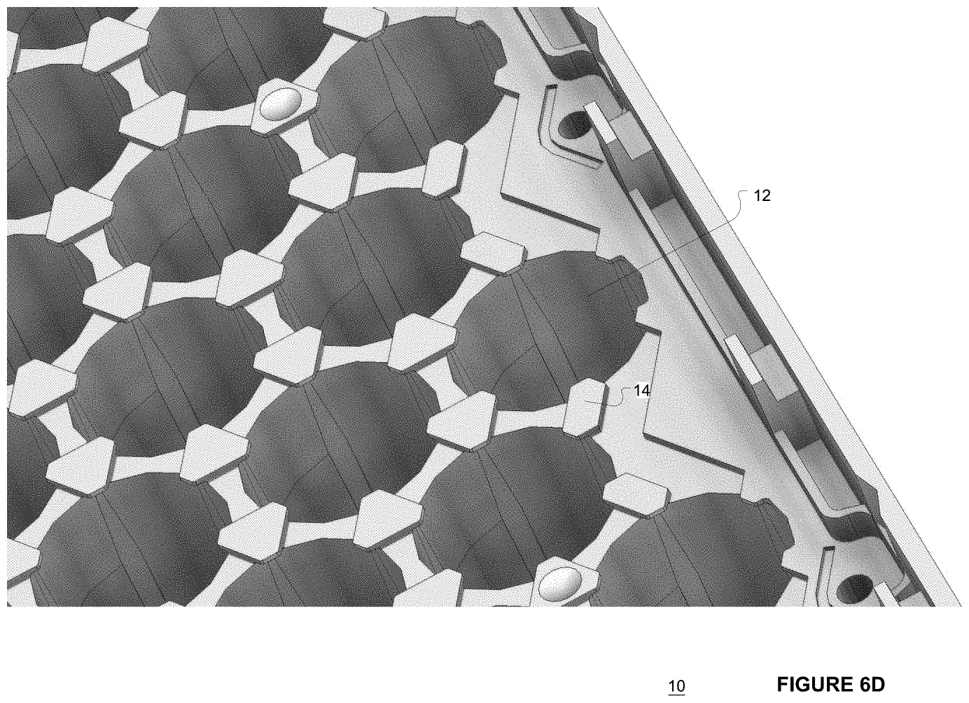

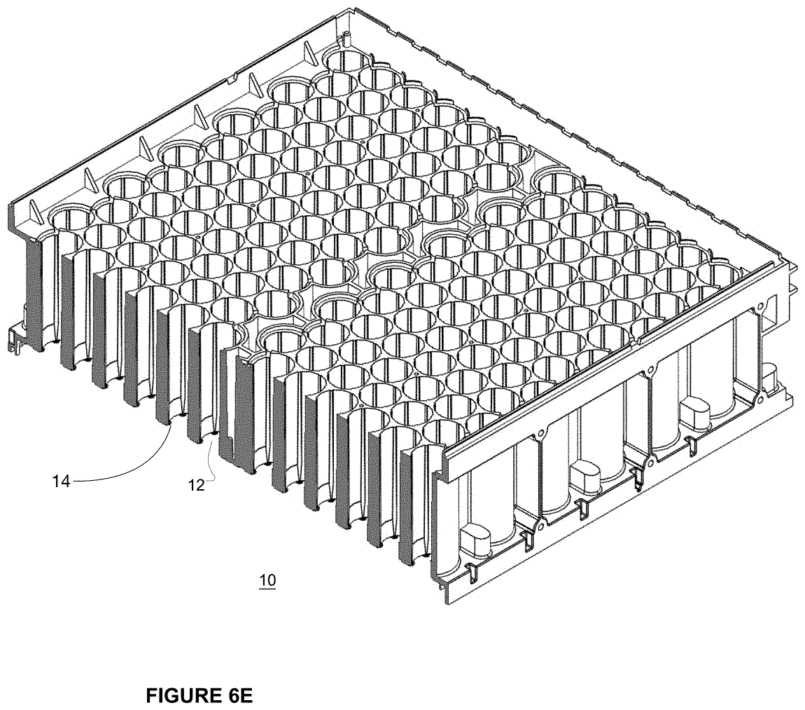

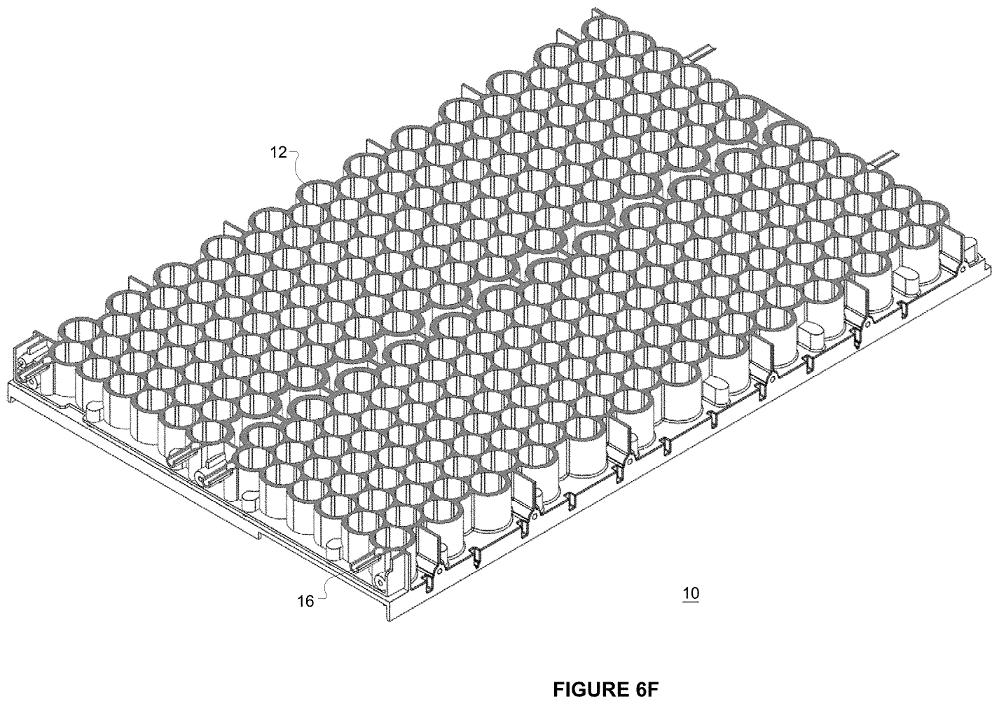

FIG. 6A is a simplified isometric drawing of thermal isolation frame (TIF) 10, separate and apart from other components of module 100. FIG. 6B is a simplified top plan view and FIG. 6C is a simplified bottom or rear side drawing of a thermal isolation frame (TIF) 10 according to an exemplary embodiment. As noted, TIF 10 provides thermal insulation between cells 50 (placed in a cell opening 12) and mechanical base or support for cells 50, EIM 30, cooling module 40, and control board 20.

FIG. 6D is a simplified enlarged perspective view of a segment of the rear side drawing of TIF 10. FIG. 6E is a simplified vertically segmented drawing and FIG. 6F is a simplified horizontally segmented drawing of a thermal isolation frame 10. As shown in FIGS. 6D and 6E, the rear or bottom cell opening 12 may include one or more raised tabs 14 that engage the bottom 54 of a cell 50 and provide a spacing between the cell 50 bottom 54 and cooling plate 40 (once installed thereon). In an embodiment, a flowable thermally conductive gel may be inserted into between the TIF 10 base via ports 16 and port holes in base 18 so the cooling plate 40 is thermally coupled to the base 54 of each cell 50 as shown in FIGS. 6A-6F. The tabs 14 may provide the needed clearance to enable gel to flow therein.

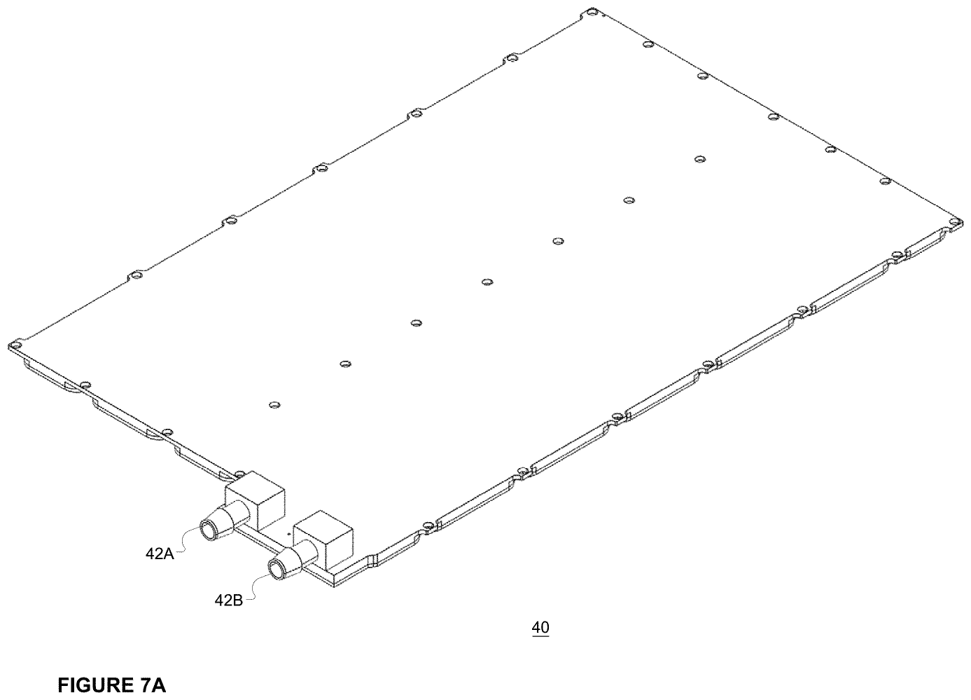

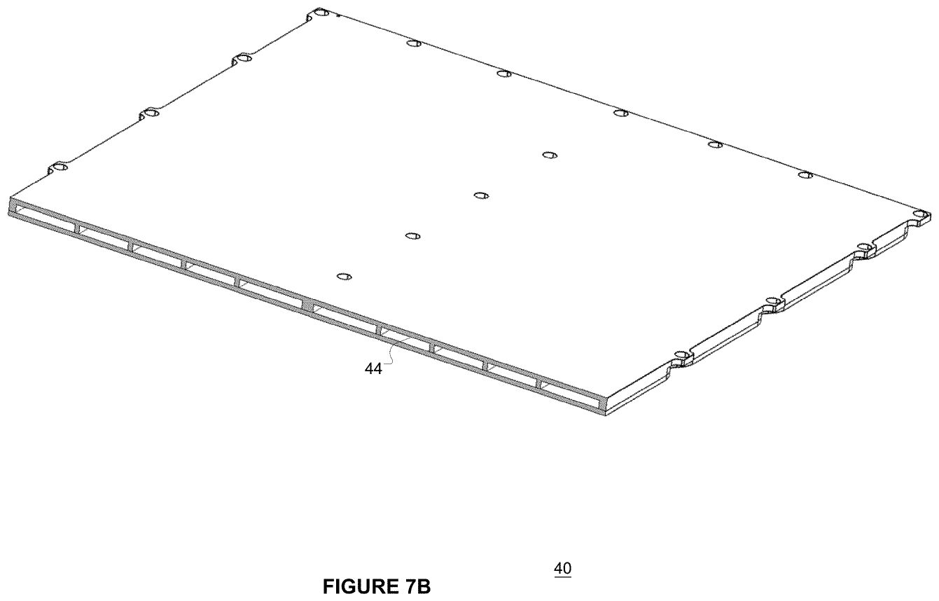

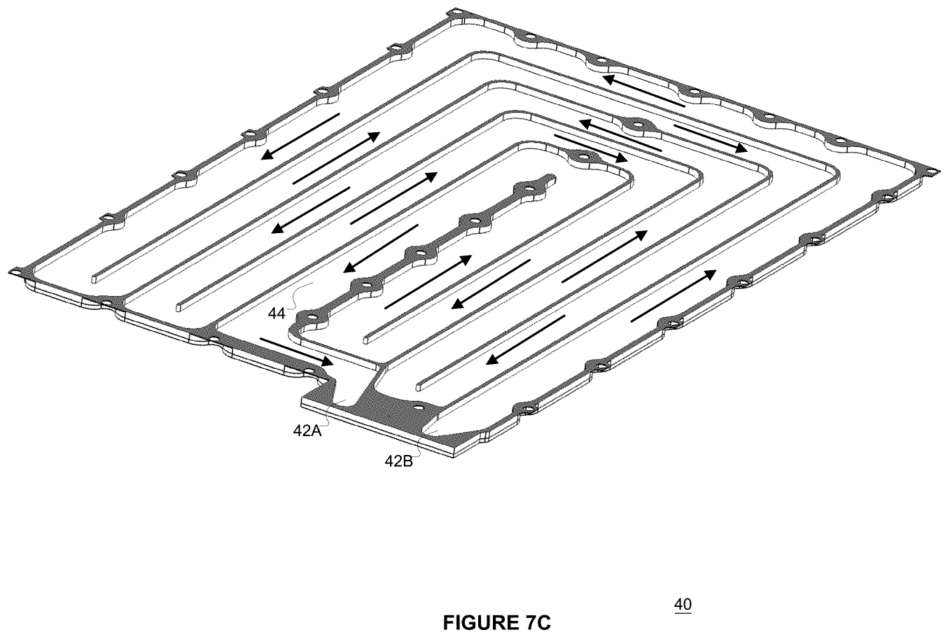

FIG. 7A is a simplified isometric drawing of a channeled cooling module 40. FIG. 7B is a simplified vertically segmented drawing of channeled cooling module 40 and FIG. 7C is a simplified horizontally segmented drawing of a channeled cooling module 40. As shown in FIGS. 7B and 7C, the cooling module 40 includes at least one channel 44 that enables flowable material, such as a coolant liquid, to traverse therethrough via ports 42A, 42B. The rate of flow of the flowable material may be controlled by temperature measurements made by a sensor board 22 traversing across the battery module 100 as shown in FIG. 1.

As described above with reference to frangible barrier 216A, 216B, in order to prevent a failing cell from encouraging other cells to fail, it may be desirable to minimize the impact of hot gas and other detritus ejected from a failing cell. Frangible barriers such as 216A and 216B provide one mechanism to allow cells to vent into an air gap for dispersion and optionally exhaust from the module, while helping shield other cells in the module from associated thermal energy, debris and corrosive detritus. However, other solutions may also be employed.

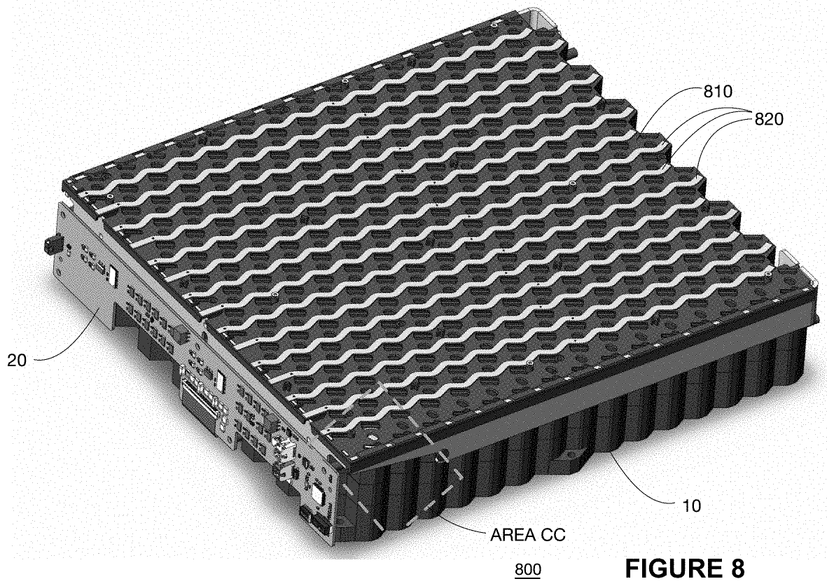

FIG. 8 illustrates another embodiment for controlling the flow of gases and detritus ejecting from a failing battery cell. Module 800 is analogous to module 100 as described hereinabove, other than as follows. In lieu of a frangible barrier (such as a dielectric gel) to protect cells 50 from a failing cell within the cell array, module 800 includes venting tray 810, positioned above TIF 10 and cells 50, but below a series of collector plates 820. Venting tray 810 is formed from a solid material, such as a plastic capable of withstanding high temperatures. Module 800 further includes collectors for electrical interconnection of battery cells. In particular, in the embodiment of FIG. 8, multiple collector plates 820 extend over and are mounted to venting tray 810. Collector plates 820 are provided in lieu of EIM 30 in module 100, to conduct power to and from cells 50 and throughout the module.

The configuration of venting tray 810 may be provided in order to achieve a number of objectives. For one, apertures in tray 810 facilitate electrical interconnection between cells 50 (positioned beneath tray 810, within TIM 10) and collector plates 820, attached to a topside of venting tray 810. Apertures within tray 810 also enable venting of hot gases and detritus from a failing cell 50, into an air gap above tray 810. However, in the event of cell failure via venting, tray 810 also protects sensitive portions of non-failing cells 50, thereby reducing likelihood of a failing cell either damaging or inducing thermal runaway of another cell positioned nearby.

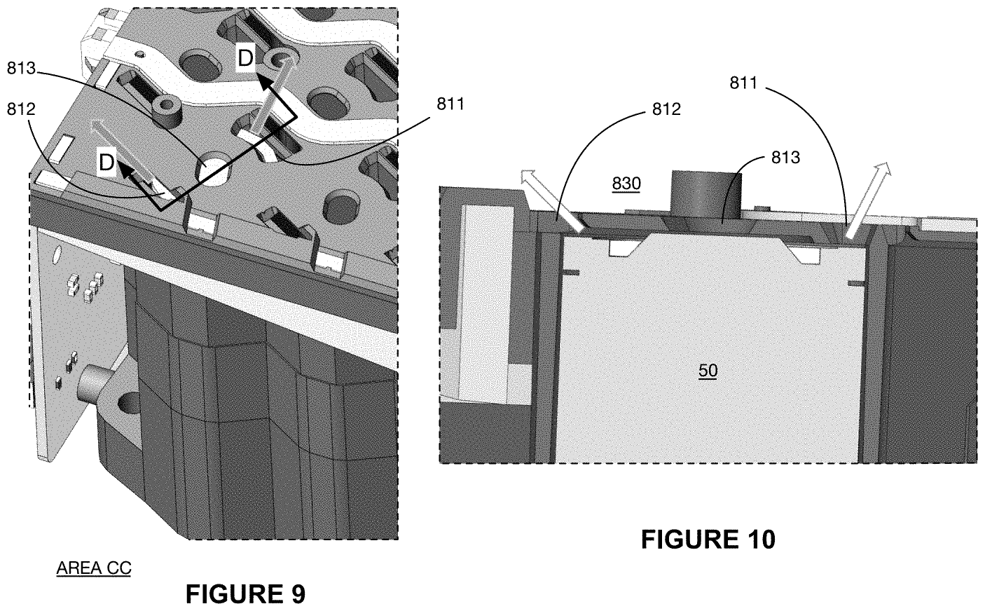

FIG. 9 is a partial cutaway perspective view of AREA CC of module 800, illustrating close up detail of a portion of venting tray 810 as installed on module 800. FIG. 10 illustrates a cross section D-D as indicated in FIG. 9. A pair of peripheral apertures 811 and 812 are provided on opposite sides of the periphery of top end 53 of a cell 50. One or more of peripheral apertures 811 and 812 may expose anode 56 of cell 50 to enable electrical interconnect of anode 56 with a collector plate 820 by, e.g., passing wiring therethrough. Central aperture 813 exposes cathode 58 of cell 50 to enable electrical interconnect of cathode 58 with a collector plate 820. In the event that cell 50 fails and ejects gases and detritus from its top, such ejecta is vented from peripheral apertures 811 and 812, and possibly via central aperture 813 as mounting pressure from cell 50 presses upward on a portion of venting tray 810 directly above the failing cell. In some embodiments, venting tray 810 will not be tightly sealed or adhered to top portion 53 of cells 50, thereby enabling upward displacement of a portion of venting tray 810 above a failing cell to further promote venting. Thus, venting tray 810 permits venting of a failing cell into air gap 830, thereby dissipating thermal energy released by the failing cell and optionally enabling exhaust of associated gases and ejecta from the module 800.

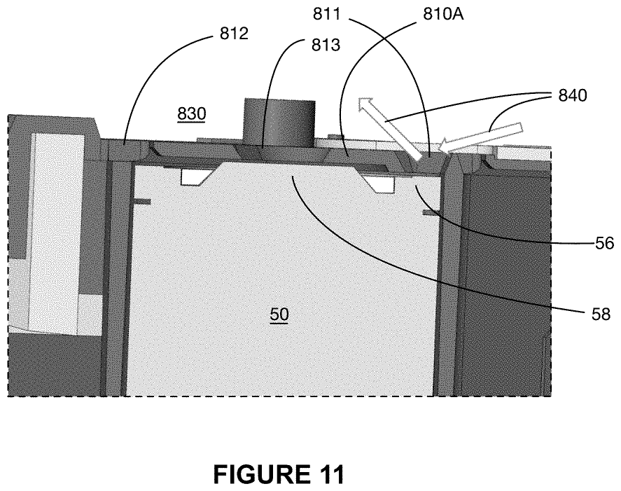

FIG. 11 is an illustration of cross-section D-D, in a scenario where cell 50 is proximate another failing cell. Ejecta 840, which may include hot gases and detritus from a failing cell elsewhere in module 800, vents through air gap 830. To the extent that ejecta 840 passes over another cell 50, portions such as portion 810A of venting tray 810 serve to shield non-failing cell 50, both physically and thermally. For example, portion 810A shields vulnerable portions of cell 50 such as a cell crimp seal that may be used during manufacture of cell 50 to secure cathode 58. In this manner, venting tray 810 may be used to permit and control the venting of failing cells, while also mitigating the impact of failing cells on other cells within a battery module.

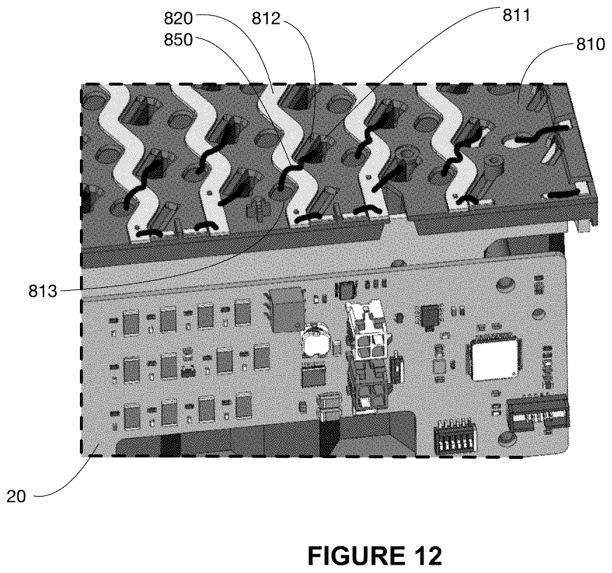

FIG. 12 is a partial perspective cutaway view of a portion of module 800, illustrating electrical interconnection of cells 50 and collector plates 820 through venting tray 810. In an exemplary embodiment, cells and collector structures may be interconnected via wire bonding. For example, a wire 850 passes from anode 56 of a first cell 50, up through peripheral aperture 811. Wire 850 is bonded to collector plate 820, and then continues through central aperture 813 for further bonding to cathode 58 of another cell. Each cell 50 may be wired in an analogous manner, via passage of wires or other conductors through apertures provided in venting tray 810.

While certain embodiments of the invention have been described herein in detail for purposes of clarity and understanding, the foregoing description and Figures merely explain and illustrate the present invention and the present invention is not limited thereto. It will be appreciated that those skilled in the art, having the present disclosure before them, will be able to make modifications and variations to that disclosed herein without departing from the scope of any appended claims.

What is claimed is:

1. A battery module comprising:
an array of battery cells, each said battery cell having a first end and a second end and a longitudinal axis generally spanning and perpendicular to the first end and the second end; the array of battery cells further having their first ends aligned with one another in a first plane, and their second ends aligned with one another in a second plane;
a frame formed of a thermal insulating material, the frame including an array of longitudinal opening between a top side and a bottom side and sized to enable each of the array of battery cells second end to pass therethrough so the respective first end of the battery cell is accessible from the frame top side; and
a vent layer positioned above the first ends of the battery cells, the vent layer configured to permit expulsion of ejecta from a failing cell from amongst the array of battery cells, into an air gap above the vent layer, the vent layer further inhibiting contact of said ejecta with one or more others of said battery cells.

2. The battery module of claim 1, wherein the vent layer comprises a frangible thermal barrier overlaying the frame opening at the first ends of the battery cells.

3. The battery module of claim 2, wherein the frangible thermal barrier comprises a dielectric gel applied over the first ends of the battery cells.

4. The battery module of claim 2, further comprising an electrical interconnect module, the electrical interconnect module comprising an insulator layer having a first side facing the battery cells, and a second side opposite the first side on which one or more conductors are mounted, each conductor being electrically interconnected with one or more of said battery cells.

5. The battery module of claim 4, in which the frangible thermal barrier is deposited between the electrical interconnect module and the first end of the battery cells.

6. The battery module of claim 4, further comprising:
a durable barrier disposed over the electrical interconnection module,
wherein the electrical interconnection module includes opening above at least a portion of the first end of each cell on which a frangible thermal barrier is overlaid, the openings communicating with an air gap between the durable barrier and the frangible thermal barrier;
whereby ejecta from the first end of a failing cell may be vented into the air gap.

7. The battery module of claim 6, in which the durable barrier comprises an aluminum plate.

8. The battery module of claim 1, in which the vent layer comprises:
a venting tray formed of a solid material, the venting tray comprising a central aperture exposing a central portion of the first end of an underlying battery cell, and at least one peripheral aperture exposing a peripheral portion of the first end of an underlying battery cell; and
one or more collectors positioned on a side of the venting tray opposite the battery cells, each collector electrically interconnected with one or more of the battery cells through the central apertures and peripheral apertures.

9. The battery module of claim 8, in which the venting tray further comprises solid portions overlying a crimp seal formed in the first end of each battery cell.

10. The battery module of claim 8, in which the at least one peripheral aperture comprises a pair of peripheral apertures positioned above opposite sides of the first end of each battery cell, and wherein a first one of each pair of peripheral apertures is utilized for interconnection of an underlying battery cell with an overlying collector.

11. The battery module of claim 10, further comprising a durable barrier positioned over the vent layer, defining the air gap between the durable barrier and underlying structures.

12. The battery module of claim 11, further comprising a port communicating between the air gap and areas outside of the battery module.

13. The battery module of claim 12, in which the port comprises a frangible cover inhibiting introduction of materials into the battery module while permitting venting of ejecta from the air gap in the event of battery cell failure.

14. The battery module of claim 12, in which the port comprises metal mesh permitting passage of gases while inhibiting passage of flames through the port.

15. The battery module of claim 1, further comprising a cooling module thermally coupled with the second end of each battery cell.
